(19) United States
(12) Patent Application Publication
(10) Pub. No.: US 2013/0221798 A1
(43) Pub. Date: Aug. 29, 2013

(54) ALTERNATOR RATIOS

(71) Applicant: Remy Technologies, LLC, (US)

(72) Inventor: Kirk Neet, Pendleton, IN (US)

(73) Assignee: REMY TECHNOLOGIES, LLC, Pendleton, IN (US)

(21) Appl. No.: 13/775,709

(22) Filed: Feb. 25, 2013

Related U.S. Application Data
(60) Provisional application No. 61/602,891, filed on Feb. 24, 2012.

(51) Int. Cl. H02K 1/22

(52) U.S. Cl. CPC H02K 1/22
USPC 310/263

(57) ABSTRACT

A vehicle alternator has a center rotational axis and includes a substantially round stator having a plurality of coils, each coil being wound a number of times N around the stator. The vehicle alternator includes a rotor having a spool with a field coil wound thereon and having an opposed pair of core segments defining a number of interleaved pole portions P, each segment having a hub radially extending a distance R2 from the center axis, each pole portion having an outer pole face a radial distance R1 from the center axis. The ratio R2/R1 is in a range of 0.60 to 0.63, and N*P is in a range of 50 to 60.

### RELATED APPLICATIONS

This application claims the benefit of U.S. Provisional Patent Application No. 61/602,891 filed on Feb. 24, 2012, which is incorporated herein by reference in its entirety.

### BACKGROUND

The invention relates generally to improvements in performance of a vehicle alternator and, more particularly, to optimizing alternator design for increasing low speed output and high speed efficiency.

A vehicle alternator generally has a rotating magnet called a rotor that turns within a stationary set of conductors called a stator. The magnetic field of the revolving rotor cuts across the conductors and thereby generates an electric current. For example, the rotor may be mechanically driven by a belt and pulley system at three times (3×) engine speed or other suitable revolutions per minute (rpm). The rotor field may be produced by energizing a rotor winding with a direct current (DC) provided through slip rings and brushes. The rotor field has a number of positive or N poles interleaved with a like number of negative or S poles. As the alternating N and S poles spin past the stator conductors, they cause current to flow first in one direction and then the other, thereby creating alternating current (AC) flow through the stator conductors. The AC current is then rectified by diodes to provide DC current for charging/recharging a vehicle battery and for powering the various electrical devices of the vehicle. Generally, for reducing noise, for increasing generated voltage at low speed, for maintaining stable performance at high speed, and for other reasons, the stator coils are typically configured to provide a three-phase or six-phase output to the rectifier diodes. A voltage regulator maintains a constant voltage at the alternator output.

Alternator performance is typically evaluated using a graph of the alternator's DC output current, in Amperes, as a function of alternator speed, in rpm's. Generally, the output current rises from zero Amps at an alternator speed that begins producing a charging current, for example 1200 rpm, to the alternator's rated output current, for example at an operating speed between 5000 and 8000 rpm. In view of such performance graphs and related performance characteristics, conventional alternators are not optimized for efficiency and performance.

### SUMMARY

It is therefore desirable to obviate the above-mentioned disadvantages by providing a vehicle alternator having both improved low speed alternator output and improved high speed alternator efficiency.

In one embodiment, a vehicle alternator has a center rotational axis and includes a substantially round stator having a plurality of coils, each coil being wound a number of times N around the stator. The vehicle alternator includes a rotor having a spool with a field coil wound thereon and having an opposed pair of core segments defining a number of interleaved pole portions P, each segment having a hub radially extending a distance R2 from the center axis, each pole portion having an outer pole face a radial distance R1 from the center axis. The ratio R2/R1 is in a range of 0.60 to 0.63, and N*P is in a range of 50 to 60.

In another embodiment, a method of providing voltage within a vehicle includes providing a substantially round stator core having a center axis, winding a plurality of coils a number of times N around the stator core, and providing a rotor having an opposed pair of core segments defining a number of interleaved pole portions P, each segment having a hub radially extending a distance R2 from the center axis, each pole portion having an outer pole face a radial distance R1 from the center axis, where R2/R1 is in a range of 0.60 to 0.63, and where N*P is in a range of 50 to 60.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a longitudinal section of a vehicle alternator;

FIG. 2 is a perspective view of a slotted stator core;

FIGS. 3A and 3B are top plan views of an individual stator slot;

FIG. 4 is a perspective view of a rotor spool;

FIG. 5 is a perspective view of a rotor pole core segment configured for a drive end of the rotor, according to an exemplary embodiment;

FIG. 6 is a perspective view of a rotor pole core segment configured for a slip ring end of the rotor, according to an exemplary embodiment;

FIG. 7 is a perspective view of the rotor spool of FIG. 4 in a folded position for protecting rotor field wiring;

FIG. 8A is a plan view and FIG. 8B is a perspective view of a rotor pole core segment configured for a drive end of the rotor, according to an exemplary embodiment;

FIG. 9 is a longitudinal section of a rotor, with components removed for illustration purposes, rotor pole core segment configured for a drive end of the rotor, according to an exemplary embodiment;

FIG. 10 shows respective rotor pole core segment cross sections of a conventional segment and a segment according to an exemplary embodiment, and compares diameter ratios thereof;

FIG. 11 is a graph of vehicle alternator performance, showing the effect of increasing diameter ratios of pole core segments;

FIG. 12 is a graph of vehicle alternator performance showing the effect of reducing N*P (stator turns times rotor poles);

FIG. 13 is a perspective view of a rotor pole core segment configured for a slip ring end of a rotor, according to an exemplary embodiment;

FIG. 14 shows respective rotor pole core segment cross sections of a conventional segment and a segment according to an exemplary embodiment, and compares radii ratios thereof;

FIG. 15 is a graph of vehicle alternator performance showing the combined effects of increasing radii ratios of pole core segments and reducing N*P (stator turns times rotor poles).

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

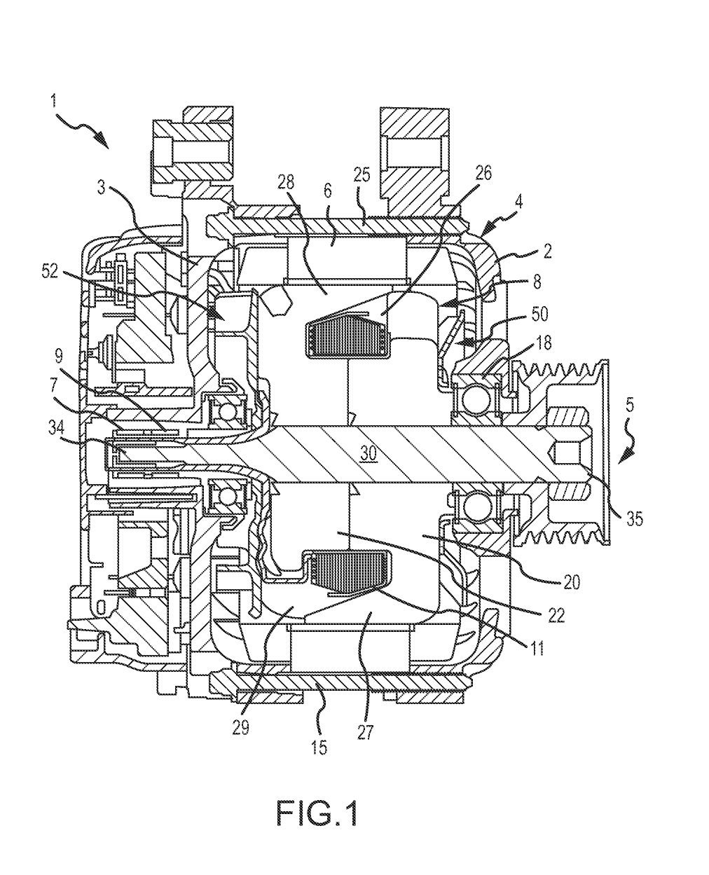

FIG. 1 is a longitudinal section of an exemplary vehicle alternator 1 having a housing 4 formed with a drive end (DE) section 2 being secured to a slip ring end (SRE) section 3 using threaded bolts 15, 25. A stator 6 is secured to housing 4 and a rotor 8 having a center shaft 30 is rotationally mounted within stator 6, being supported by first and second bearing assemblies 18, 19. Pulley 5 is mounted to drive end 35 of shaft 30 and is typically structured for being driven by a belt (not shown) to thereby rotate shaft 30 of rotor 8. Respective DE and SRE fans 50, 52 are attached to rotor 8 and generate a cooling air flow through alternator 1 when shaft 30 is rotated. Slip rings 7, 9 are secured around slip ring end 34 of shaft 30, and are respectively in electrical communication with the ends of rotor field winding 11 which is wound around a spool of rotor 8 as described below. For example, the ends of field winding 11 may be welded, soldered, brazed, or otherwise connected to slip rings 7, 9. A body portion of rotor 8 is formed as two opposed halves, namely DE segment 20 and SRE segment 22, each including a plurality of pole portions. For example, DE segment 20 includes pole portions 26, 27 and SRE segment 22 includes pole portions 28, 29. Rotor pole core segments 20, 22 are typically formed of steel.

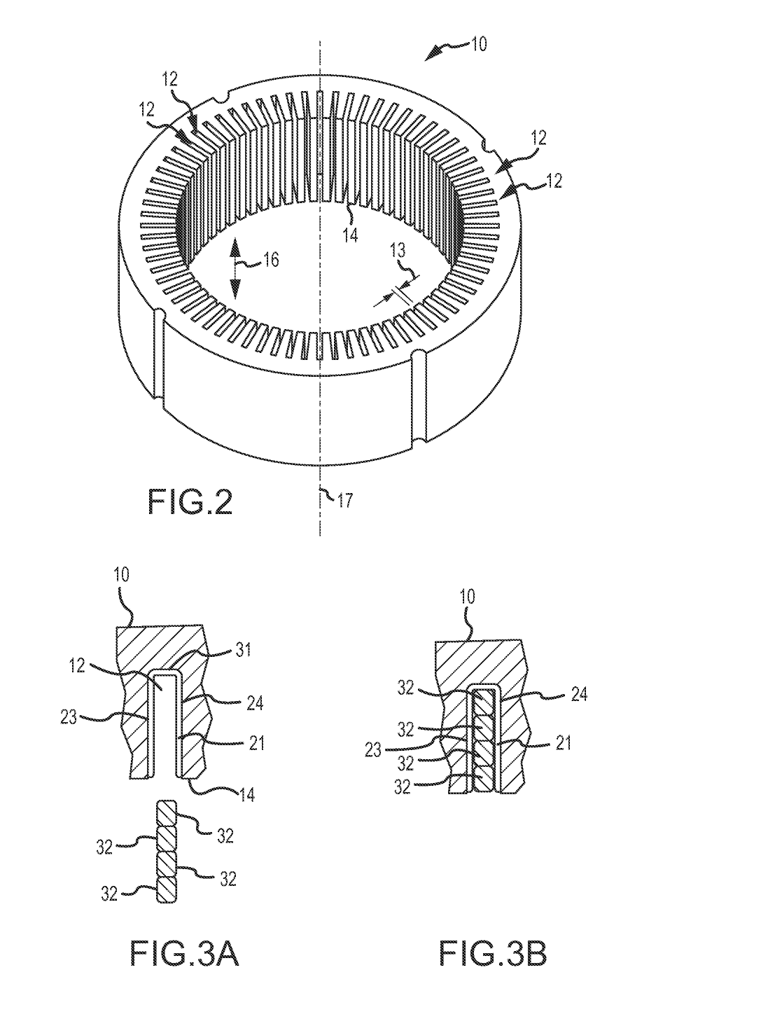

FIG. 2 is a perspective view of a substantially columnar stator core 10 having a center axis 17. In an exemplary embodiment, stator core 10 has 84 radially-extending slots 12 each extending radially outward of a circumferential inner surface 14 and each having a width 13. Slots 12 are shown by example extending between axial ends of stator core 10 in an axial direction indicated by arrow 16, parallel to center axis 17.

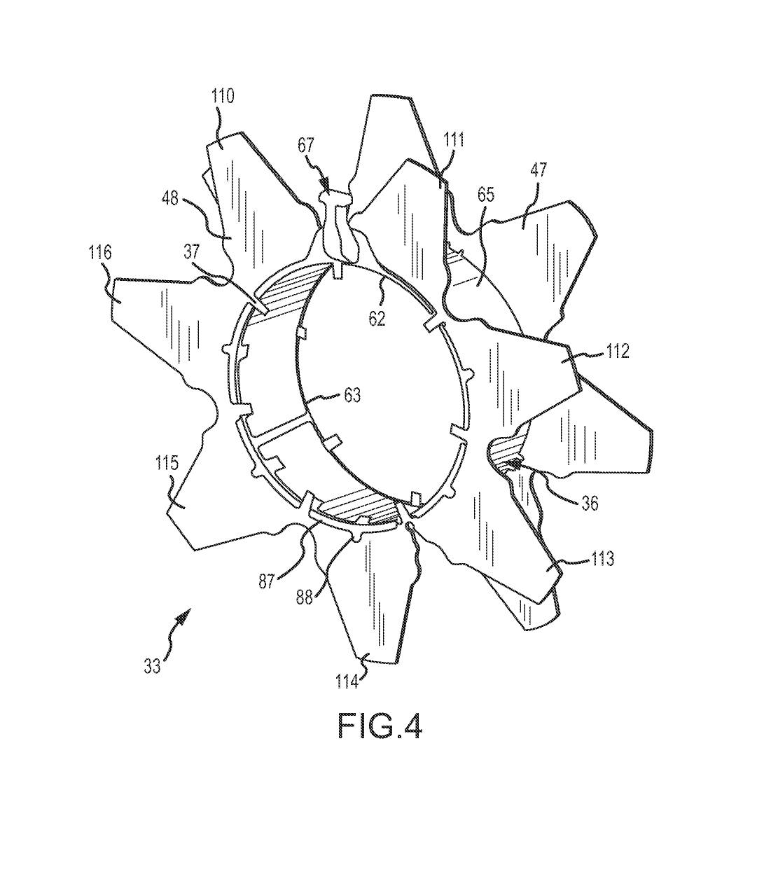

FIG. 3A and FIG. 3B are top plan views of one of the core slots 12. A slot liner 21 is an insulator that covers the side walls 23, 24 and the back wall 31 for the axial length of each slot 12. Each insulated slot generally has a substantially rectangular cross-sectional profile structured for receiving a number of conductor segments 32. In the illustrated example, four conductor segments 32 are inserted into slot 12 after slot liner 21 has been installed. Conductor segments 32 each have a substantially rectangular cross-sectional profile with slightly rounded corners, whereby the group of conductor segments 32 fits closely into insulated slot 12. Other conductor profiles, such as square, round, elliptical, and others may be used in a given embodiment. Slot liners 21 electrically insulate the installed conductor segments 32 from stator core 10, and may be formed of a sheet type insulator attached to one or more walls 23, 24, 31 of slot 12 with an adhesive that is bonded and cured prior to insertion of conductor segments 32. FIGS. 3A-3B show conductor segments 32 at four radial positions in slot 12. For example, when each of the stator phases includes a single wire or coil that goes around stator 6 four times then there may be four conductor segments 32 per slot 12. When each phase has two coils connected in parallel that each go around stator four times, there may be eight conductor segments 32 per slot 12. In either case, the number of stator turns N is four. It should be noted that the number of turns N as used herein to describe exemplary embodiments refers to a stator winding having a Wye connection which is commonly known in the industry. By comparison, a stator winding having a Delta connection (also well known in the industry) requires 1.732 times as many turns as a Wye winding to have similar current outputs. Therefore, when considering a Delta winding, N equals the number of turns in the Delta winding divided by 1.732.

Stator 6 may be formed by inserting slots 12 with conductor segments 32 according to a chosen multi-phase winding pattern. For example, each phase may have a plurality of conductor segments 32 inserted into slots 12 to be alternately connected at opposite axial ends of stator core 10 by a plurality of end loop segments (not shown). U.S. Pat. No. 7,788,790, granted to Kirk Neet and incorporated herein by reference, discloses a method and structure for forming a stator using conductor segments. The rectangular profile of conductor segments 32 is typically used for high slot fill windings. The end loop segments may be interlaced or cascaded. An interlaced winding includes a majority of end loop segments that connect a slot segment housed in one core slot and in one radial position with a slot segment housed in another core slot in a different radial position. A cascaded winding includes a majority of end loop segments, which connect a slot segment housed in a radial position of a core slot with another slot segment housed in the same radial position of another core slot. A variety of wiring and connection patterns may be utilized in forming a stator. Typically, either three or six phase stator windings are provided for vehicle alternator 1, where a six-phase vehicle alternator is generally quieter.

FIG. 4 is a perspective view of a spool assembly 33 used for securing field winding 11 within rotor 8. In order to increase the copper fill of the rotor, the spool used to insulate rotor coil 11 from the rotor poles has a spool body 65 formed of plastic or the like and two star portions 47, 48 formed of a stamped sheet which has a high tear strength. This spool design allows for higher rotor copper fill than the conventional rotor spool formed of 100% plastic or the like. In the conventional spool, the plastic flaps tear easy during the assembly process. Therefore, the conventional spool assembly causes the rotor copper fill to be reduced to compensate for the easy-to-tear flaps. Star portions 47, 48 are respectively disposed at opposite axial ends of spool body 65. For example, each star portion 47, 48 is formed of a stamped sheet material that may be a laminate material such as, but not limited to, Polyester/Nomex®/Polyester or Polyimide/Nomex®/Polyimide. Star portions 47, 48 each have seven radially extending flaps 110-116. Spool body 65 may be formed of an injection molded plastic or other suitable lightweight, strong, electrically insulating material. Spool body 65 may include a wire tie-off post 67. Star portions 47, 48 are secured to spool body 65 so that flaps 110-116 of star portion 47 are aligned with notches 36 of star portion 48. Spool body 65 includes retainer projections 87, 88 circumferentially spaced along each axial end 62, 63 thereof for securing star portions 47, 48 to spool body 65. In addition, star portions 47, 48 each include circumferentially spaced attachment projections 37 that are folded inwardly into the annular center of spool body for further securing star portions to spool body 65.

Rotor field winding 11 is formed by wrapping insulated magnet wire around spool body 65. For example, magnet wire may be a chamfered square or round copper wire having one or more resin, enameled, or coated (e.g., varnish, polyurethane/nylon) insulating layers, and is typically chosen for characteristics that include abrasion resistance, workability, heat dissipation, durability, cost, dielectric properties, solvent resistance, and others. For example, magnet wire may have multiple coatings using materials such as cross-linked, modified polyester and amide-imide polymer. The insulation prevents the magnet wire from short-circuiting. The ends of the field winding are electrically connected to respective slip rings 7, 9, for example by soldering. The magnet wire may have any given profile, for example round, and typically has a size in the range of AWG #18-22 for twelve volt vehicle alternator applications, and a smaller size such as AWG #30 or smaller for twenty-four or thirty-six volt vehicle alternators.

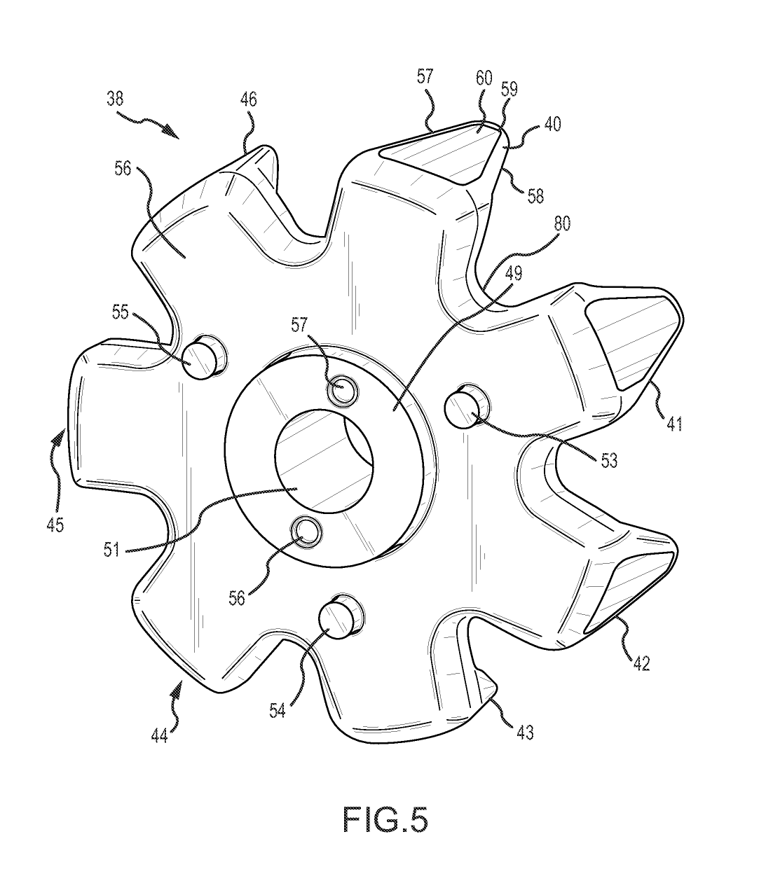

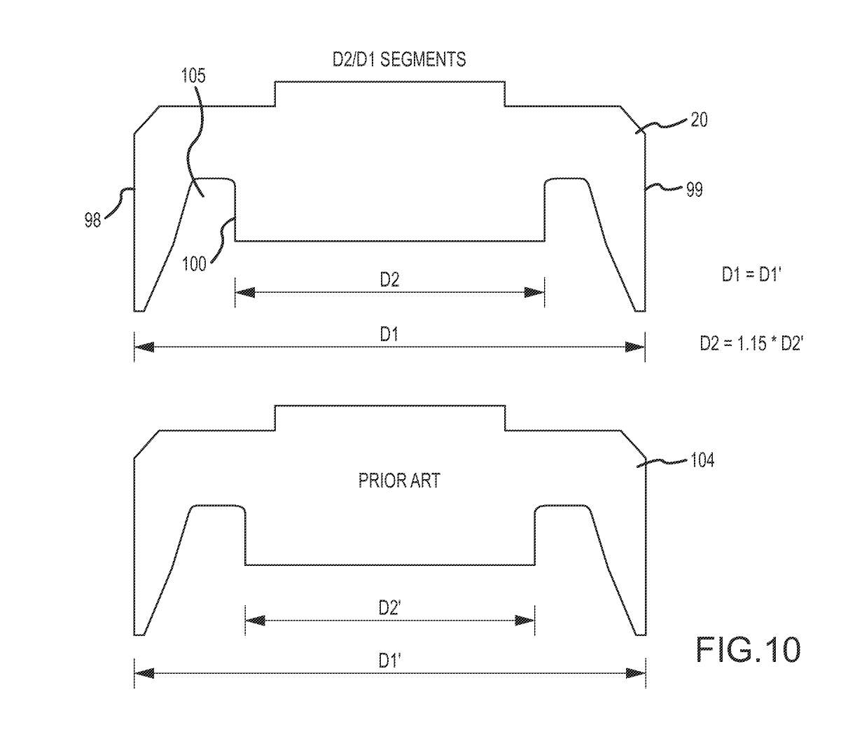

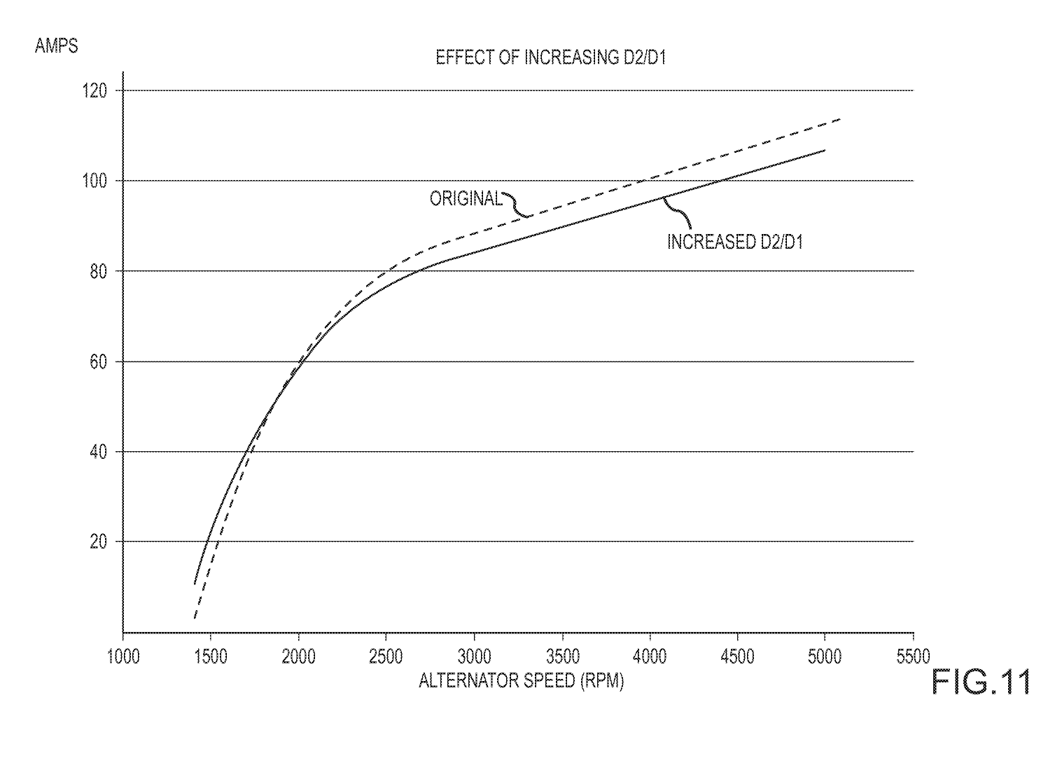

FIG. 5 is a perspective view of a DE segment 38 that is an exemplary rotor pole core having seven poles 40-46. DE segment 38 has three engagement projections 53, 54, 55 and a raised annular center portion 49, all axially extending from core surface 56 for mounting fan 50 thereto. For example, fan 50 may have three engagement holes (not shown) that align with engagement projections 53, 54, 55, and may have an annular coupling portion (not shown) that engages center portion 49, whereby fan 50 may be properly installed onto DE segment 38. After fan 50 has been properly placed into position, a pressing operation flattens projections 53, 54, 55 to thereby radially extend outwardly of the engagement holes which secures fan 50 to DE segment 38. Two threaded receptacles 117, 118 are provided in an axial direction for location of DE segment and rotor 8 during the assembly process. A center bore 51 of DE segment 38 is provided for mounting DE segment 38 on shaft 30 of alternator 1. Bearing assemblies 18 may be press fit onto shaft 30. Poles 40-46 extend radially outward as equally spaced, claw-shaped protrusions each extending axially in a direction away from surface 56 and bearing assembly 18. Each pole 40-46 has opposed sides 57, 58 typically tapered in one or more dimensions (see, e.g., FIGS. 10A-10B) and approaching one another as they axially extend away from surface 56 to respective ends 59. Each pole 40-46 has a radially outward facing surface 60 that is typically axially aligned.

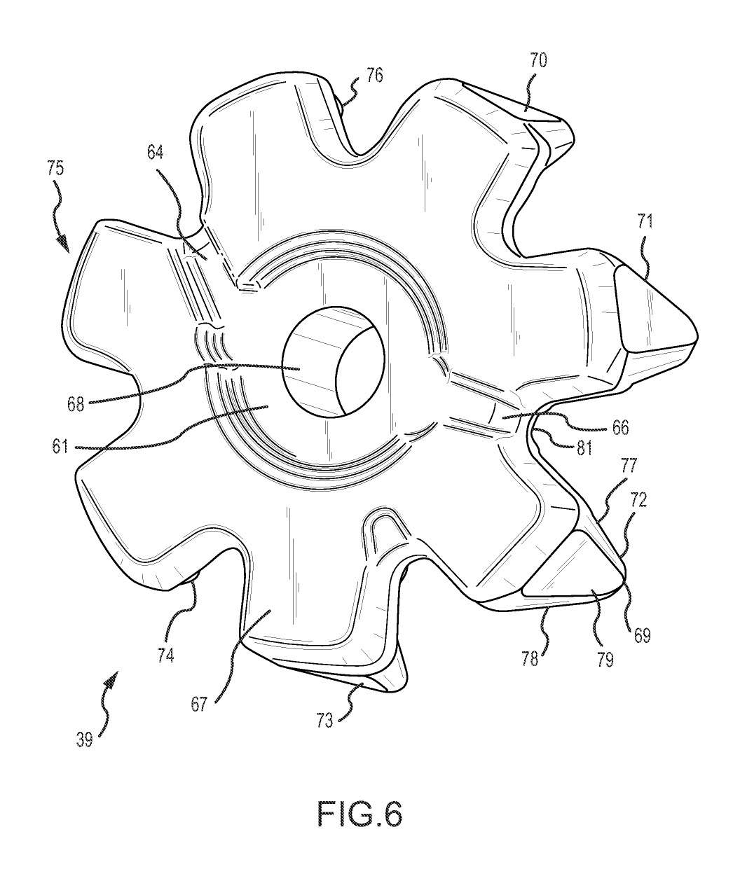

FIG. 6 is a perspective view of an SRE segment 39 that is an exemplary rotor pole core having seven poles 70-76 and that is shaped substantially similar to DE segment 38. SRE segment 39 may have two key indentations 64, 66 axially indented into core surface 67 for routing by mounting the ends of rotor field winding 11 thereto. An indented annular center portion 61 also axially extends from core surface 67 for mounting bearing assembly 19 thereto. A center bore 68 of SRE segment 39 is provided for mounting SRE segment 39 on shaft 30 of alternator 1. Poles 70-76 extend radially outward as equally spaced, claw-shaped protrusions each extending axially in a direction away from surface 67 and bearing assembly 19. Each pole 70-76 has opposed sides 77, 78 typically tapered in one or more dimensions (see, e.g., FIGS. 10A-10B) and approaching one another as they axially extend away from surface 67 to respective ends 69. Each pole 70-76 has a radially outward facing surface 79 that is typically axially aligned.

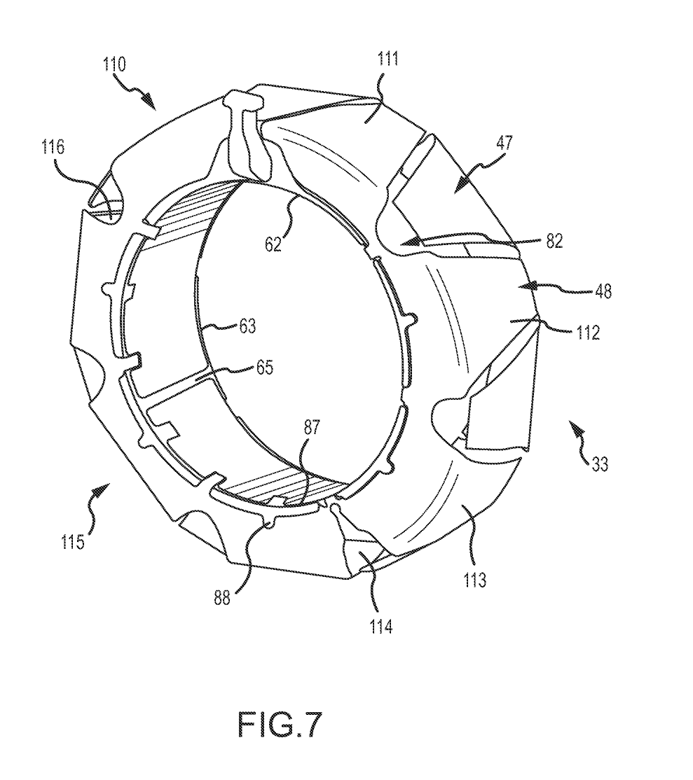

After rotor field winding 11 has been wound onto spool assembly 33, DE segment 38 and SRE segment 39 are pushed onto shaft 30 so that respective surfaces 56, 67 face in opposite axial directions, whereby each of the respective pole ends 59 of DE segment 38 is aligned with a corresponding notch 81 of SRE segment 39 and whereby each of the respective pole ends 69 of SRE segment 39 is aligned with a corresponding notch 80 of DE segment 38. Pole core segments 38, 39 are aligned with spool assembly 33 so that when poles 40-46 of DE segment 38 contact flaps 110-116 of star portion 48, flaps 110-116 of star portion 48 are folded under as shown in FIG. 7. In like manner, when poles 70-76 of SRE segment 39 contact flaps 110-116 of star portion 47, flaps 110-116 of star portion 47 are folded under. Each pole 40-46, 70-76 is shaped like and aligned with a corresponding one of the fourteen folded flaps (each respective star portion 47, 48 has seven flaps 110-116, not separately labeled), whereby each flap completely protects and electrically insulates the underlying wire of rotor field winding 11, omitted from wire location 82 of FIG. 7 for illustration purposes. In particular, the insulating coating of the magnet wire can be nicked or rubbed by metal portions of pole core segments 38, 39 during assembly, and such undesirable contact may create short-circuiting of field winding 11. If such undesirable contact creates a weak or damaged wire portion, an open-circuit or excessive winding resistance may occur either upon contact or as a latent defect. Each flap 110-116 has a shape substantially similar to each pole 40-46, 70-76, whereby there is no possibility that any exposed metal pole portions come into contact with the magnet wire. By protecting the magnet wire with flaps 110-116, undesirable damage is avoided.

When the rotor core is assembled, poles 40-46 are interleaved with poles 70-76, for a total of fourteen poles. Typically, a vehicle alternator has 12 to 16 poles. In operation, electric current is supplied from a battery and brushes (not shown) to slip rings 7, 9 connected to rotor field winding 11, thereby generating magnetic flux. The claw-shaped poles 40-46 of DE segment 38 are thereby magnetized into North-seeking (N) poles by the magnetic flux, and the claw-shaped poles 70-76 of SRE segment 39 are thereby magnetized into South-seeking (S) poles. Rotational torque from a vehicle engine is applied to pulley 5 of alternator 1, thereby rotating rotor 8. The magnetic field thereby becomes a rotating magnetic field that generates electromotive force in the stator windings. The alternating N and S poles passing by the stator coils create an alternating current (AC) voltage therein, which is rectified by diodes (not shown) and output from alternator 1 as a DC voltage.

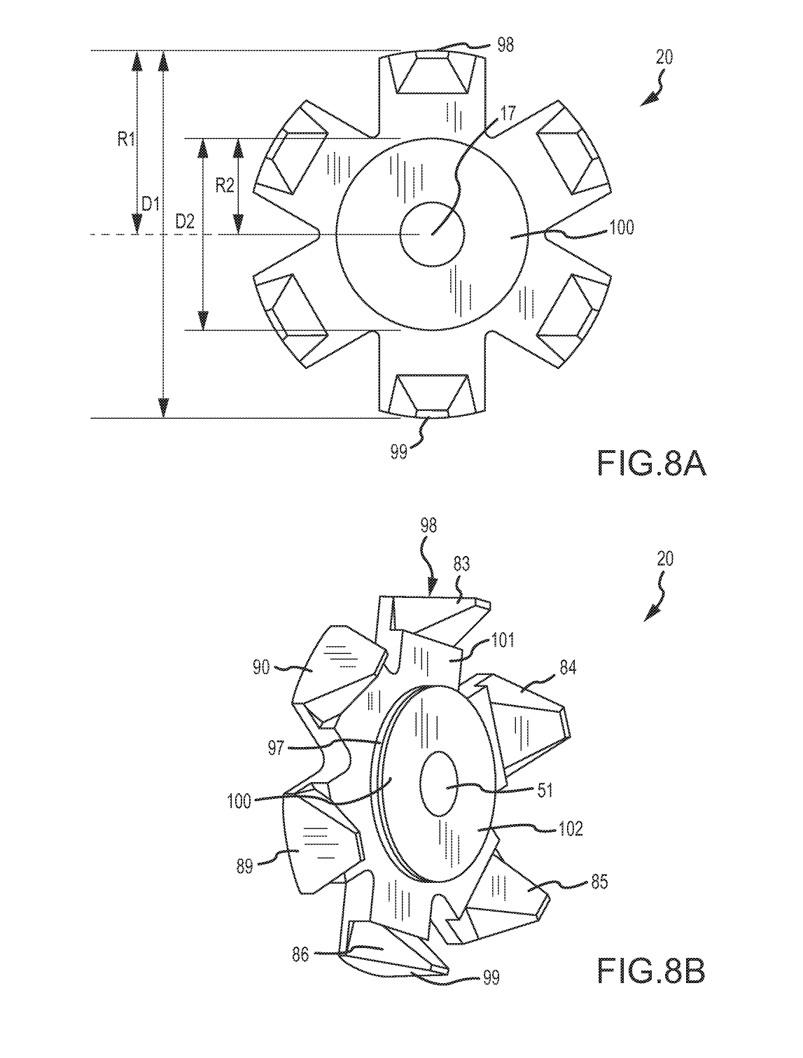

FIG. 8A is a plan view and FIG. 8B is a perspective view of an exemplary DE segment 20, which has six poles 83, 84, 85, 86, 89, 90. Mating DE segment 20 with a corresponding six pole SRE segment 22 produces a twelve pole rotor core. DE segment 20 has an annular center hub/boss portion 100 coaxial with a center bore 51 and extending axially inwardly from inner pole core surface 101. Such axial extension forms a columnar surface 97 defining the outside diameter of hub portion 100. Typically, depending on a chosen method of manufacturing, hub surface 97 may be slightly askew with respect to center axis 17. For example, columnar surface 97 of hub 100 may diverge away from center axis 17 by an angle of approximately two to three degrees as surface 97 axially extends from pole core surface 101 to inner hub surface 102. Accordingly, any such deviations in the diameter D2 of hub 100 are utilized for defining an approximate tolerance value for hub diameter D2. As used herein, the diameter D1 of DE segment 20 is defined as the distance between distal pole faces, for example the distance along D1 between pole face 98 and pole face 99. Radius R1 is the distance from center rotational axis 17 to columnar surface 97 and radius R2 is the distance between axis 17 and any radially outward facing pole face, for example the radial distance to pole face 98. The description of diameters D1, D2 are generally applicable to a rotor pole core segment having distal poles defined along a single diameter line, and radii R1, R2 are generally applicable to a given rotor pole core segment having any number of poles. For this reason, a twelve pole rotor core is used herein for generically describing principles of exemplary embodiments that may be easily illustrated by reference to diameters and cross-sectional views. Stated differently, a longitudinal section view can only show a rotor pole core profile with distal poles along a single diameter when each rotor core segment (e.g., segments 20, 22) has an even number of poles. Accordingly the alternator ratio D2/D1 is expressed as R2/R1 for segments having an odd number of poles (e.g., segments 38, 39).

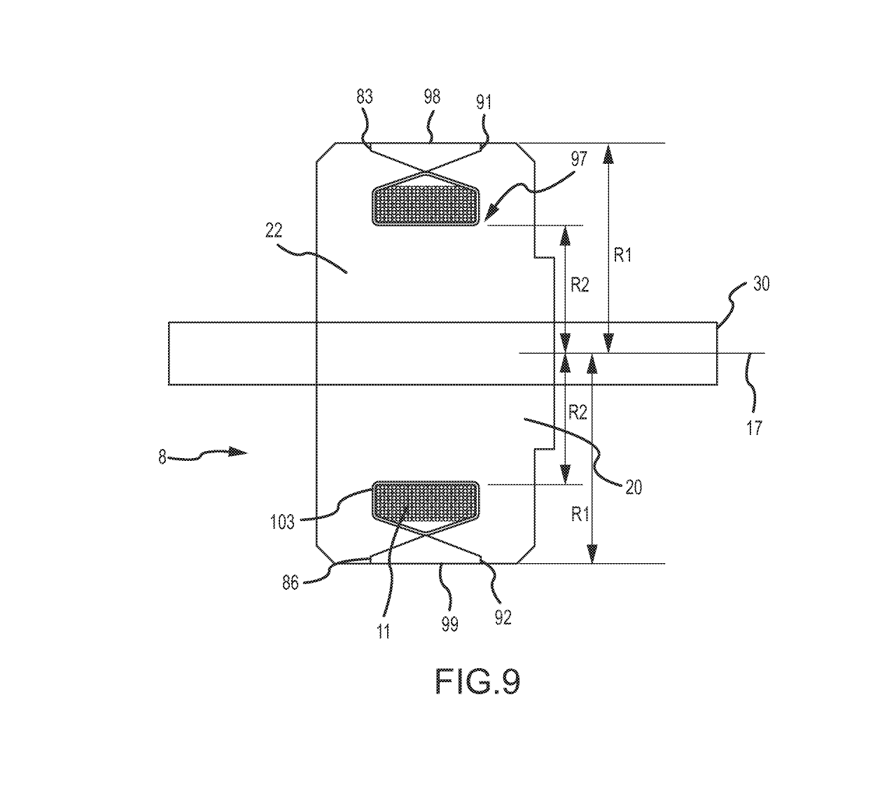

FIG. 9 is a longitudinal section of an assembled rotor 8 with some components removed for illustration purposes. A standard rotor cross-section is shown where, for example, the total number of poles (e.g., 12 poles) allows the cross-section view to include poles of a pole core segment at opposite radial sides of the view. For example, DE segment 20 has radially distant poles 83, 86 and SRE segment 22 has radially distant poles 91, 92. Each pole core segment 20, 22 has a radius R1 measured from center rotational axis 17 to the outer face of any corresponding pole and has a radius R2 measured from axis 17 to the corresponding boss/hub surface. Pole core segments 20, 22 are each fitted onto shaft 30. Spool 103 is formed in the same manner as described above for spool assembly 33 (e.g., FIG. 4 and FIG. 7), except that is has twelve flaps instead of fourteen. Spool 103 partially encloses and thereby electrically insulates and physically protects field winding 11 from damage that might result from contact with pole core segments 20, 22.

Improved alternator performance at low speed (e.g., rpm <1800) is desirable. In a typical case, when a vehicle is idling, vehicle alternator 1 may have a speed of approximately 1600 rpm, depending on pulley ratios or other application-specific characteristics. When a large current is required by various electrical devices being supplied with electrical power by alternator 1, running at low speed, there may be insufficient alternator output current to meet the demand. For example, while idling, a vehicle may have a refrigeration unit for its cargo area, an air conditioner or a heater for a cabin, various lights including headlights, music amplifiers, various other electrical devices, and one or more batteries requiring charging, when the outside temperature may be extremely cold or hot, whereby a large alternator current is being demanded.

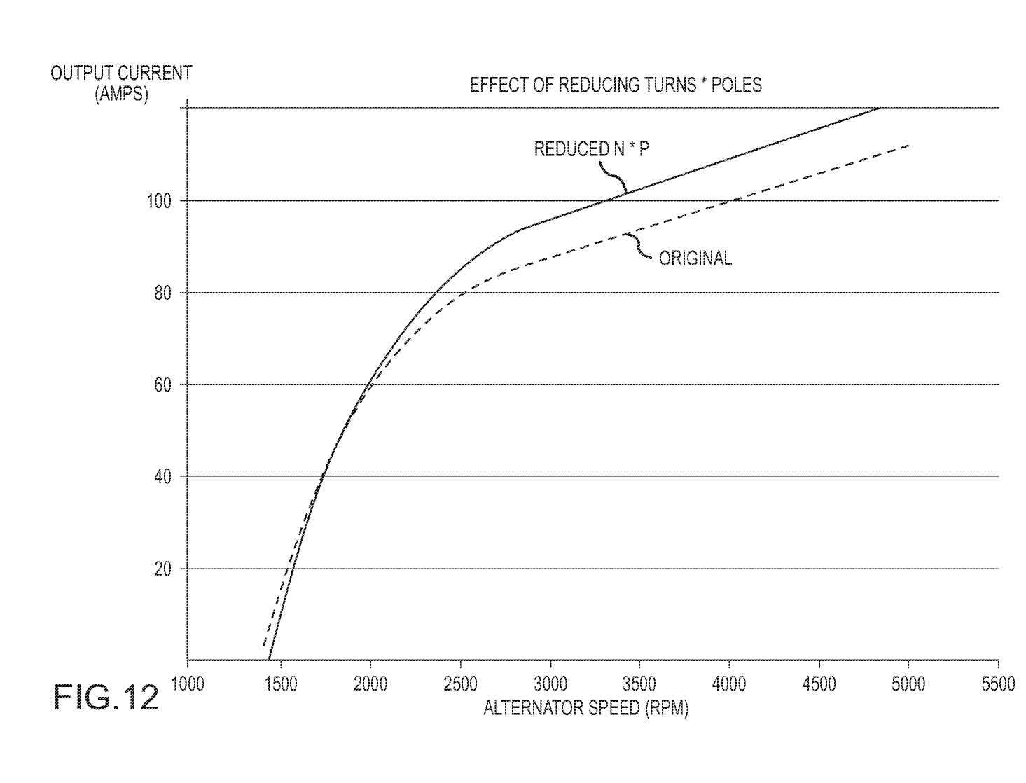

FIG. 10 compares the respective pole core segment profiles of an embodiment, for example DE segment 20, and a conventional rotor core segment 104. Pole core segment 20 has a diameter D1 between pole faces 98, 99 and has a diameter D2 that is the outside diameter of hub 100. Rotor core segment has corresponding diameters D1′ and D2′ defined in the same manner. Increasing the ratio D2/D1 to be greater than 0.60 increases the low speed alternator output by reducing reluctance, but such reduces the alternator's high speed output because rotor field core 11 is smaller as a result of there being less space available in the annular wiring region 105 located between hub 100 and poles 83-86, 89, 90. The smaller field coil 11 has lower amp-turns. FIG. 11 is an exemplary graph that shows the above-described effect of increasing the ratio D2/D1 on alternator performance. In the illustrated example, the diameter D1 of DE segment 20 is equal to the diameter D1′ of conventional pole core segment 104, and the diameter D2 of DE segment 20 is 1.15 times diameter D2′ of segment 104. FIG. 11 shows vehicle alternator performance with D2′/D1′ of 0.57 as the original curve and with D2/D1 of 0.61 as the increased D2/D1 curve. The increase of D2/D1, by itself, results in reduced output at high speed.

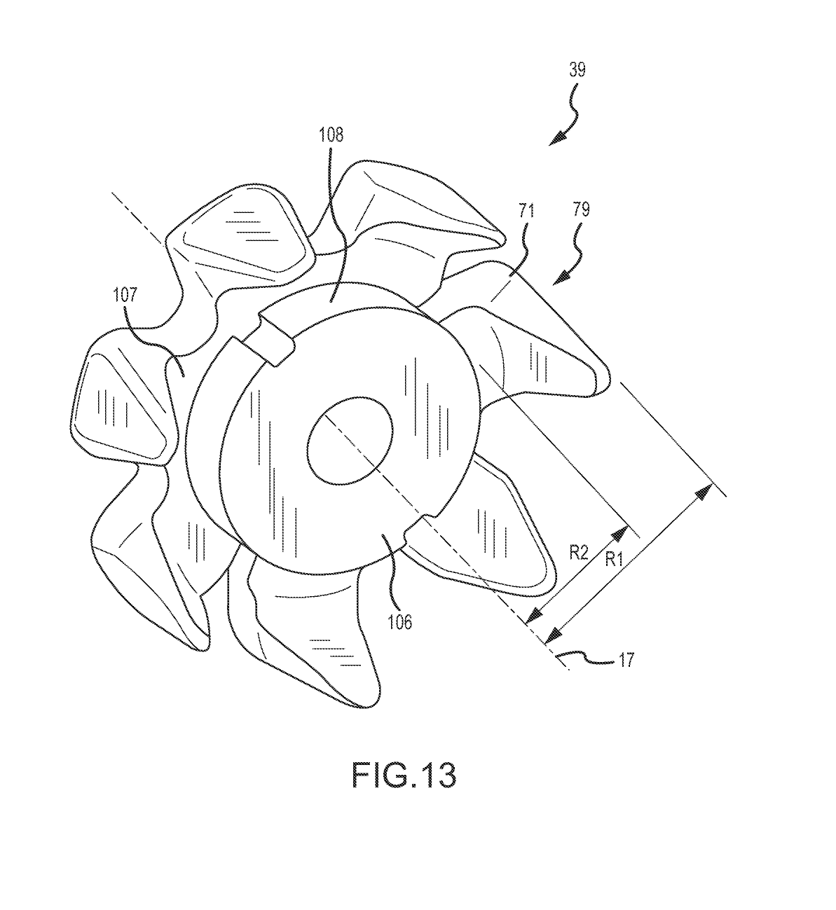

An alternator may have a number of wire turns N in its stator and a number of poles P in its rotor. A substantially round stator may have a plurality of coils, each coil being wound a number of times N around the stator. Typical vehicle type alternators may have stators with four to six turns N and have rotors with twelve to sixteen poles P. Such typical alternators have an N*P (stator turns times rotor poles) factor of 64 (e.g., 4*16) to 90. Reducing the N*P factor reduces alternator output at low speed (e.g., rpm <1800) because, generally, the voltage induced in each stator phase is V=N*(dφ/dt), where dφ/dt is the rate of change of flux. However, reducing the N*P factor increases alternator output at high speed because of the relative increase in stator coil inductance. FIG. 12 is an exemplary graph that shows the above-described effect of reducing the N*P factor on alternator performance. FIG. 12 shows vehicle alternator performance with N*P of 64 as the original curve and with N*P of 56 as the reduced N*P curve. It is desirable to have lower amp-turns to reduce the stator resistance and associated I²R losses in the stator, thereby increasing alternator efficiency. However, the desire to increase high speed efficiency by simply reducing the N*P factor causes a drop in alternator low speed output that is contrary to the desire to improve alternator output when the vehicle is at idle, for example at a typical alternator idle-state speed (e.g., 1600 rpm).

In an exemplary embodiment, an alternator 1 balances the opposing design desires of improving low speed alternator output and improving alternator efficiency. Such increase in low speed output and improved efficiency is provided by combining a low N*P of fifty to sixty with a high D2/D1 ratio of 0.60 to 0.63. As a result of testing, it has been found that a vehicle alternator meets the desired performance by having an N*P factor of 56 turns*poles (e.g., 4 stator turns times 14 rotor poles) and a D2/D1 ratio of 0.61. Since a radius is defined as half the length of a diameter (see, e.g., FIG. 9), the ratio R2/R1=D2/D1.

FIG. 13 is a perspective view of SRE segment 39 showing an annular inner hub 106 axially extending inwardly from rotor core surface 107. Hub 106 has a radius R2 defined as the distance from center rotational axis 17 to the outer circumferential surface 108. SRE segment 39 has a radius R1 defined as the distance from axis 17 to the outer face 71 of each pole, for example pole 79.

After assembly, rotor 8 may be machined by a turning operation, whereby the outside diameter (OD), diameter D1, is adjusted to a precise length. By precise control of rotor diameter D1, the vehicle alternator output is optimized by assuring that the distance between rotor 8 and stator 6 is minimized, and by assuring that such distance (“air gap”) is consistent around the circumference of rotor 8. For example, when pole core segments 38, 39 are formed and installed with a diameter D1 that is intentionally slightly large, the installation of segments 38, 39 onto bearing assemblies 18, 19 and shaft 30 is performed to initially assure concentricity of the components. Thereafter, during the turning operation, the radially outward portions of segments 38, 39 are machined off, whereby the rotor 8 OD and radii R1 are brought within a very tight dimensional tolerance. Therefore, the dimensions R1, R2, R1′, R2′ and D1, D2, D1′, and D2′ apply to the finished rotor assembly and are only shown on individual poles, for example poles 83-86, 89, 90 of FIGS. 8A-8B, for ease of description.

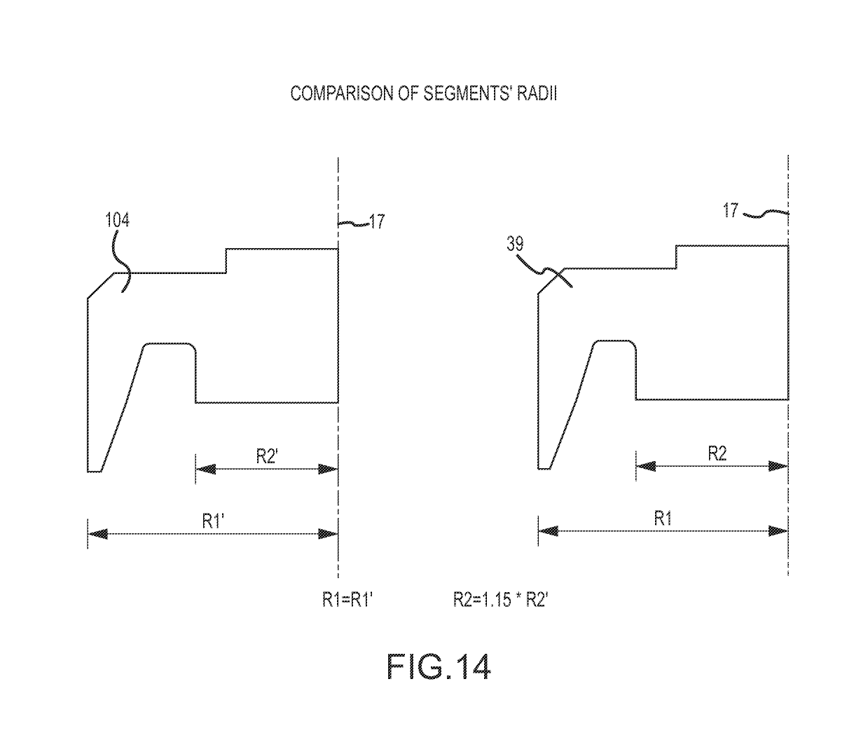

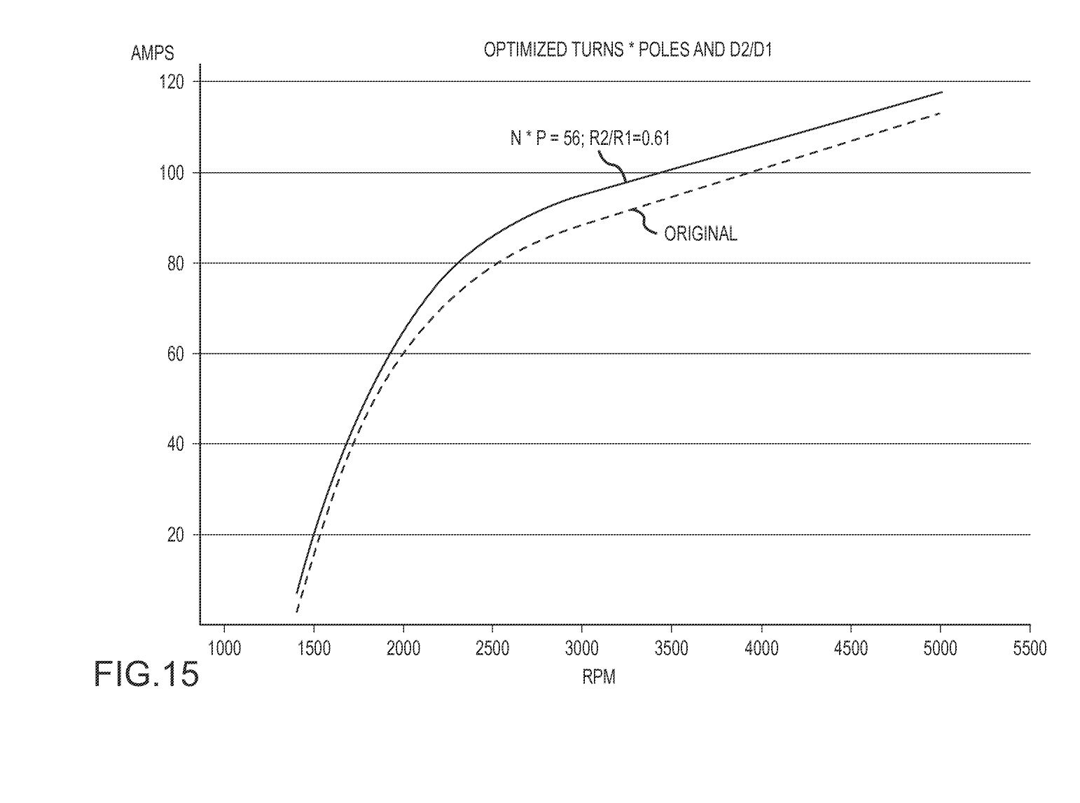

FIG. 14 compares the radii R1′, R2′ of a conventional rotor pole segment 104 with the radii R1, R2 of an embodiment, for example SRE segment 39. Radius R1 of SRE segment 39 has the same length as radius R1′ of segment 104. The radius R2 of SRE segment 39 is a length approximately 1.15 times radius R2′ of segment 104.

Testing of the optimized vehicle alternator ratios, combining an N*P factor of 56 with an R2/R1 ratio of 0.61, yielded results shown in the graph of FIG. 15. The “original” curve used for comparison represents results for a vehicle alternator having an N*P factor of 64 and an R2′/R1′ ratio of 0.54. In this example, the ratio R2/R2′ is 1.13 (0.61/0.54), which approximates the R2/R2′ ratio of 1.15 shown in FIG. 14. The comparison shows that the optimized alternator ratios provide improved low speed alternator output together with improved high speed alternator output.

It is desirable to reduce the number of turns N in a high slot fill stator because additional turns of a high slot fill stator are increasingly difficult to make. For example, for a stator winding made of hairpin type conductor segments, additional windings necessitates a greater number of welds, and for various types of continuous windings the additional windings create a longer zig-zag shape (see, e.g., U.S. Pat. No. 7,911,105, granted to Kirk Neet). The larger D2/D1 ratio allows a reduction of the N*P factor while still maintaining low speed alternator output performance. The larger D2/D1 ratio is made possible, for example, by utilizing a spool assembly having thin, tear-resistant protective portions that allow a high copper fill field coil to be wound on a rotor otherwise having less available copper space. In addition, utilizing a high slot fill stator (for example a stator having square wire arranged in single rows of a rectangular slot) reduces the resistance of the stator, allows a stator to have a larger inside diameter (ID), and allows a rotor to have a larger outside diameter (OD). The larger rotor OD increases dφ/dt. The lower stator resistance also boosts low speed vehicle alternator output, whereby a given output may be maintained with a reduced number of turns N.

Typically, rotor 8 in a given embodiment may have magnets (not shown) interposed between poles, for example in a space such as notch 80 between poles 40, 41 (e.g., FIG. 5) and very close to the exterior of rotor 8. For example, magnets may be placed into slots (not shown) in rotor pole core segments. Magnets may be placed in any pole space or vicinity, such as near an end of a pole (e.g., near end 59 of pole 40 in FIG. 5), depending on requirements of turning rotor 8 for dimensional tolerancing. The magnets prevent magnetic flux in rotor 8 from leaking between adjacent poles instead of going into stator 6.

Stator 6 and rotor 8 may each include various compounds, sealants, epoxy, varnish, and the like for protecting, securing, and stabilizing the corresponding coils and windings. For example, a vehicle alternator 1 is subject to extensive vibration. By seating and stabilizing such as with varnish, rubbing together and eventual shorting of wires is prevented. For example, the use of spool assembly 33 allows more wire fill compared with many conventional rotor spools, and it is necessary to maintain a strong rotor winding structure that is stable.

The higher proportion of wire fill allowed by use of spool assembly 33 having thin materials results in higher amp turns for rotor field winding 11, and thereby allows a rotor 8 structure having a large D2/D1 ratio and an associated small radial area for the wiring. As a result of spool assembly 33 taking up less space and having thin protection flaps 110-116 made of a material having excellent abrasion resistance properties, the higher wire fill of field winding 11 provides improved performance. The thin protection flaps 110-116 prevent rotor poles from contacting field winding 11 during rotor assembly and thereafter.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A vehicle alternator having a center rotational axis, comprising:
a substantially round stator having a plurality of coils, each coil being wound a number of times N around the stator; and
a rotor having:
a spool with a field coil wound thereon; and
an opposed pair of core segments defining a number of interleaved pole portions P, each segment having a hub radially extending a distance R2 from the center axis, each pole portion having an outer pole face a radial distance R1 from the center axis;
wherein R2/R1 is in a range of 0.60 to 0.63, and wherein N*P is in a range of 50 to 60.

2. The vehicle alternator of claim 1, wherein N is 4.

3. The vehicle alternator of claim 2, wherein P is 14.

4. The vehicle alternator of claim 3, wherein R2/R1 is approximately 0.61.

5. The vehicle alternator of claim 1, wherein the spool has a pair of opposed star members defining P star portions that are substantially aligned with ones of the pole portions for electrically insulating the pole portions from the field coil.

6. The vehicle alternator of claim 5, wherein the star members are formed of a stamped sheet material.

7. The vehicle alternator of claim 6, wherein the stamped sheet material is a laminate.

8. The vehicle alternator of claim 7, wherein the laminate includes a layer of Nomex.

9. The vehicle alternator of claim 5, wherein the spool includes a spool body.

10. The vehicle alternator of claim 9, wherein the spool body is formed of plastic.

11. The vehicle alternator of claim 1, further comprising a pair of slip rings in electrical communication with the field winding and structured for receiving a voltage.

12. A method of providing voltage within a vehicle, comprising:
providing a substantially round stator core having a center axis;
winding a plurality of coils a number of times N around the stator core; and
providing a rotor having an opposed pair of core segments defining a number of interleaved pole portions P, each segment having a hub radially extending a distance R2 from the center axis, each pole portion having an outer pole face a radial distance R1 from the center axis;
wherein R2/R1 is in a range of 0.60 to 0.63, and wherein N*P is in a range of 50 to 60.

13. The method of claim 12, further comprising installing a spool within the rotor, the spool having a field coil wound thereon for creating a rotating magnetic field when the rotor rotates about the center axis.

14. The method of claim 13, wherein the spool comprises a spool body and a pair of star portions respectively disposed at axial ends of the spool body, each star portion having a plurality of flexible flaps arranged to align with poles of the core segments, and wherein the step of installing the spool comprises pressing the core segments axially toward one another so that the flaps are folded between respective ones of the poles and the field coil.

15. A vehicle alternator having a center rotational axis, comprising:
a substantially round stator having a plurality of coils, each coil being wound a number of times N around the stator; and
a rotor having:
a spool with a field coil wound thereon; and
an opposed pair of core segments defining a number of interleaved pole portions P, each segment having a hub radially extending a distance R2 from the center axis, each pole portion having an outer pole face a radial distance R1 from the center axis;
wherein R2/R1 is in a range of 0.60 to 0.63, N*P is in a range of 50 to 60, the spool has a spool body and a pair of opposed star members respectively mounted at opposite axial ends of the spool body and defining P star portions, the spool body is formed of a plastic material, and wherein the star portions are formed of a sheet material.

16. The vehicle alternator of claim 15, wherein N is 4.

17. The vehicle alternator of claim 16, wherein P is 14.

18. The vehicle alternator of claim 16, wherein R2/R1 is approximately 0.61.
